(19) United States
(12) Patent Application Publication
(10) Pub. No.: US 2014/0321930 A1
(43) Pub. Date: Oct. 30, 2014

(54) Hand Tool Operating Unit

(71) Applicant: Robert Bosch GmbH, Stuttgart (DE)

(72) Inventors: Klaus Dengler, Kornwestheim (DE); Wolfgang Hirschburger, Reutlingen (DE); Christopher Wiess, Leinfelden (DE)

(73) Assignee: Robert Bosch GmbH, Stuttgart (DE)

(21) Appl. No.: 14/255,030

(22) Filed: Apr. 17, 2014

(30) Foreign Application Priority Data
Apr. 29, 2013 (DE) 10 2013 207 777.7
Feb. 13, 2014 (DE) 10 2014 202 585.0

(51) Int. Cl. B23Q 15/007; B23B 45/02; B23Q 5/10

(52) U.S. Cl. CPC B23Q 15/007; B23Q 5/10; B23B 45/02; B23B 2270/32; B23B 2270/48
USPC 408/8; 173/2; 173/176

(57) ABSTRACT

A hand tool operating unit includes at least one operating member, and an electronic operating unit that has a position sensor configured to ascertain a position of the operating member. The hand tool operating unit additionally includes at least one further sensor that is configured to ascertain at least one characteristic variable.

This application claims priority under 35 U.S.C. §119 to patent application no. DE 10 2013 207 777.7, filed on Apr. 29, 2013 in Germany, and to patent application no. DE 10 2014 202 585.0, filed Feb. 13, 2014, the disclosures of which are incorporated herein by reference in their entirety.

### BACKGROUND

The prior art already discloses an operating unit having at least one operating means and an electronic operating unit that comprises a position sensor that is proposed for the purpose of ascertaining a position of the operating means.

### SUMMARY

The disclosure relates to a hand tool operating unit having at least one operating means and an electronic operating unit that comprises a position sensor that is provided for the purpose of ascertaining a position of the operating means.

It is proposed that the hand tool operating unit comprises at least one further sensor that is provided for the purpose of ascertaining at least one characteristic variable. The term an “operating means” is to be understood in particular to mean a means that can be actuated by the operator during a working procedure for the purpose of influencing a movement of a selected tool. It is preferred that the operating means is mounted in such a manner that the operator can move said operating means relative to at least one region of the electronic operating unit. In particular, the term an “electronic unit” is to be understood to mean an electronic operating unit that is provided at least for the purpose of converting a position of the operating means into an electrical motor control signal that is dependent upon the position of the operating means. It is preferred that the electronic operating unit comprises a circuit board that is in particular in one piece and that connects means, devices and sensors of the electronic operating unit in an electrically conductive and mechanical manner. As an alternative or in addition thereto, means, devices and sensors of the electronic operating unit can be wired to one another. It is preferred that the electronic operating unit of the hand tool operating unit comprises precisely one circuit board that is provided for the purpose of connecting at least sensors and advantageously at least one power control means and/or an evaluating device of the electronic operating unit in an electrically conductive and mechanical manner. Alternatively, the hand tool operating unit could comprise at least two circuit boards that are provided in each case for the purpose of contacting a part of the devices and sensors of the electronic operating unit in an electrically conductive and mechanical manner. In particular, one of the circuit boards could be provided for the purpose of contacting the sensors and in particular the evaluating device in a conductive and mechanical manner, and one of the circuit boards could be provided for the purpose of contacting at least one of the power control means of the electronic operating unit in a conductive and mechanical manner. In a further embodiment in accordance with the disclosure, the electronic operating unit of the hand tool operating unit could comprise a circuit board that contacts the sensors of the electronic operating unit in an electrically conductive and mechanical manner. In this case, a hand tool that comprises the hand tool operating unit comprises an electronic unit that comprises at least one power control means. The evaluating device could in this case be part of the electronic operating unit of the hand tool operating unit and/or advantageously be part of the electronic unit of the hand tool. It is preferred that the electronic operating unit comprises a voltage supply device that is provided for the purpose of providing a suitable supply voltage for the purpose of operating the means, devices and sensors of the electronic operating unit. The term a “position sensor” is to be understood in particular to mean a sensor that is provided for the purpose of outputting an electrical signal dependent upon a state of the operating means that can be influenced by an operator. It is preferred that the electrical signal is dependent upon a generated force and/or advantageously on a spatial position of a body part of the operator. In particular, the electrical signal is dependent upon a spatial position of the operating means, in particular relative to a grip of a hand tool that comprises the hand tool operating unit. It is preferred that the position sensor is provided for the purpose of varying an electrical resistance dependent upon the position of the operating means. The term “position” can describe a spatial characteristic of the operating means and/or a different characteristic of the operating means, said different characteristic appearing expedient to the person skilled in the art. In particular, the position sensor could ascertain a different change in a characteristic variable that appears expedient to the person skilled in the art, said characteristic variable preferably being a capacity, an inductance and/or a resistance ratio. It is preferred that the position sensor outputs an electrical motor control signal. The term “motor control signal” is to be understood to mean in particular a signal and dependent upon said signal a power control means of the hand tool or advantageously of the electronic operating unit controls and/or regulates a motor output. It is preferred that the motor control signal is at least essentially proportional to the motor output that is output by the power control module. The term “provided” is to be understood to mean in particular especially programmed, designed and/or embodied. The term is to be understood in particular to mean that an object is provided for a specific function, that the object fulfills and/or performs this specific function in at least one application state and/or operating state. The term “position of the operating means” is to be understood in particular as a characteristic of the operating means that describes an actuation by means of the operator. In an advantageous manner, the position of the operating means is dependent upon an arrangement and/or an alignment at least of one operating surface of the operating means. As an alternative or in addition thereto, the position of the operating means can be dependent upon a force on the operating means and/or on a position of a part of body on the operating means. It is preferred that the operating means comprises at least two different possible positions, it is particularly preferred that the operating means comprises more than two possible positions. In particular, the term “ascertain” is to be understood to mean that the sensor converts a non-electrical characteristic variable into an electrical signal. The term “sensor” is understood to mean in particular a means that is provided for the purpose of outputting a signal that is dependent upon a characteristic variable that is as a result of an external influence and is in particular non-electrical. The arrangement in accordance with the disclosure of the hand tool operating unit renders it possible to retrofit an existing hand tool type in an advantageous manner with a function that is based on the further sensor.

In a further embodiment, it is proposed that the electronic operating unit comprises the further sensor, as a consequence of which it is possible to achieve a particularly cost-effective construction.

Furthermore, it is proposed that the further sensor is provided for the purpose of ascertaining at least one characteristic variable of a movement of an uncontrolled blocking incident, as a consequence of which it is possible to provide in a structurally simple manner a hand tool that is particularly reliable and safe. The term “characteristic variable of a movement of an uncontrolled blocking incident” is to be understood to mean in particular a movement that the hand tool performs if the selected tool becomes blocked in a work piece during a working procedure. In an advantageous manner, the sensor is provided for the purpose of ascertaining a linear movement and/or in particular in an advantageous manner a rotary movement. As an alternative or in addition thereto, a further sensor is provided for the purpose of ascertaining a different operating characteristic variable that appears expedient to the person skilled in the art, by way of example a temperature, a gas, wear on a selected tool and/or any risk of injury to the operator posed by the selected tool.

Moreover, it is proposed that the further sensor is embodied as an acceleration sensor, as a consequence of which it is possible to ascertain in an advantageous manner the uncontrolled blocking incident. The term “acceleration sensor” is to be understood to mean in particular a sensor that is provided for the purpose of outputting a signal that is dependent upon the acceleration of the sensor. In an advantageous manner, the acceleration sensor is provided for the purpose of ascertaining a rotary acceleration and/or in particular in an advantageous manner a linear acceleration. As an alternative or in addition thereto, a further sensor could be embodied as a different sensor that appears expedient to the person skilled in the art, by way of example as a temperature sensor and/or a gas sensor.

In addition, it is proposed that the hand tool operating unit comprises an evaluating device that is provided for the purpose of influencing and/or generating a motor control signal in dependence upon a signal from the further sensor, as a consequence of which it is possible to achieve a particularly simple construction. It is preferred that the electronic operating unit comprises an evaluating device. This is understood to mean that the evaluating device is arranged on the circuit board of the electronic operating unit. The term “evaluating device” is to be understood to mean in particular a device that is provided for the purpose of interrupting an output of a driving power in at least one operating state advantageously in the case of an ascertained uncontrolled blocking incident, even though a position of the operating means has been allocated to an output of a different driving power, said position being received by the position sensor. The term “signal” is to be understood to mean in particular an electrical characteristic variable that transports information in at least one operating state. In particular, the term “dependent” is understood to mean that the evaluating device captures the signal from the further sensor and depending upon the state of the signal influences the output of a driving power. In particular, the term “influence” is understood to mean that the evaluating device modifies a value of the motor control signal in such a manner that the power control means modifies the motor power that is output. It is preferred that the evaluating device modifies the motor control signal in such a manner that the motor of the hand tool stops in a particularly active or passive manner. The term “generate” is to be understood to mean in particular that the evaluating device, in particular a microcontroller of the evaluating device, receives and processes the signals from the position sensor and from the further sensor and said evaluating device outputs the motor control signal.

Furthermore, it is proposed that the evaluating device is provided for the purpose of interrupting an output of a driving power in dependence upon a signal from the further sensor, as a consequence of which it is possible to achieve a construction having a particularly simple motor connector. In particular, the motor connector requires only two contacts. The term “driving power” is to be understood to mean in particular a power that a motor of the hand tool converts into mechanical energy for the purpose of driving the selected tool. It is preferred that the driving power is derived from a motor current, a motor voltage and a signal form of the driving power. It is preferred that the driving power is transmitted by way of an alternating voltage, in particular a supply voltage. As an alternative, the driving power could be transmitted by means of a direct voltage, in particular a voltage of a rechargeable battery. In particular, the term “interrupt an output” is to be understood to mean that the electronic operating unit prevents the electric power that drives the motor from flowing in the direction of the motor.

Furthermore, it is proposed that the evaluating device comprises a microcontroller, as a consequence of which it is possible to program a function which renders further flexible development possible. The term “microcontroller” is to be understood to mean in particular a device having a processor, a storage unit and/or an operating program, control program and/or calculating program that are stored in the storage unit.

In an advantageous embodiment of the disclosure, it is proposed that at least the evaluating device is embodied using analogue technology, as a consequence of which it is possible to achieve a particularly cost-effective construction. The term “analogue technology” is to be understood to mean a construction that does not comprise a microcontroller. It is preferred that the evaluating device comprises passive components, such as for example resistors, capacitors, inductors and/or memristors, and active components, such as for example diodes, transistors, optocouplers and/or relays.

Moreover, it is proposed that the hand tool operating unit comprises a power control means that is provided for the purpose of controlling a driving power in particular in dependence upon the motor control signal, as a consequence of which it is possible to forego an electronic unit in the hand tool outside the hand tool operating unit. It is preferred that the electronic operating unit comprises the power control means. In particular, the power control means is arranged on the circuit board of the electronic operating unit. The term “power control means” is to be understood to mean a means that is operatively arranged between an energy input, in particular of the hand tool and/or the hand tool operating unit, and the motor and said means controls and/or regulates a driving power that is received by the motor. It is preferred that the power control means comprises at least one electronic power component, by way of example a thyristor, a transistor and/or advantageously a triac. The term “energy input” is to be understood to mean a connector by way of which the hand tool is supplied with electrical energy.

Furthermore, it is proposed that the hand tool operating unit comprises at least one motor connector that is provided for the purpose of outputting driving power in particular to a motor of the hand tool, as a consequence of which it is possible to achieve a simple construction of the hand tool operating unit in the hand tool. The term “motor connector” is to be understood to mean a means that is provided for the purpose of connecting the motor in an electrically conductive manner. It is preferred that the motor connector comprises an electric plug connection. In particular, the term “outputting” is to be understood to mean that the driving power enters the hand tool operating unit by way of the energy input and exits the hand tool operating unit by way of the motor connector.

In addition, it is proposed that the hand tool operating unit comprises an operating unit housing element that is provided for the purpose of connecting the operating means and the electronic operating unit to form an assembly, as a consequence of which it is possible to achieve an advantageous assembly process. The term “operating unit housing element” is to be understood to mean in particular a means that is provided for the purpose of producing a mechanical connection between the components of the hand tool operating unit. It is preferred that the operating unit housing element fastens a circuit board of the electronic operating unit. In an advantageous manner, the operating unit housing element comprises a bearing means for moveably fastening the operating means. It is preferred that the operating unit housing element is provided for the purpose of encompassing the electronic operating unit in a protective manner. In particular, the term “assembly” is to be understood to mean a group of components that can be assembled separately from the remaining part of the hand tool to form a mechanically and electrically connected unit. The assembly is installed as a whole unit into the hand tool during a production of the hand tool.

Furthermore, it is proposed that the operating unit housing element is provided for the purpose of being installed in a hand tool housing that is at least essentially in the form of a pistol-shaped and/or D-shaped grip, as a consequence of which it is possible to retrofit an existing hand tool type having this grip shape in an advantageous manner with a function based on the further sensor. In particular, the term “at least essentially in the form of a pistol-shaped grip” is understood to mean that a main working direction is aligned at least essentially in a perpendicular manner with respect to a main extension of the grip. The term “in the form of a D-shaped grip” is to be understood to mean that the grip comprises a protective frame that lies in the main working direction away from a gripping surface of the grip and said protective frame encompasses a gripping region of the grip at least in part. In particular, the term “hand tool housing” is to be understood to mean a housing that connects at least the motor, a gear mechanism and the hand tool operating unit to one another. In particular, the hand tool housing encompasses at least essentially the motor and the gear mechanism. It is preferred that the hand tool housing forms the grip.

Furthermore, the disclosure relates to a hand tool, in particular a hand-held drilling machine, having a hand tool operating unit in accordance with the disclosure. In particular, the term “hand tool” is understood to mean a tool that appears expedient to the person skilled in the art, however, it is understood to mean advantageously a drilling machine, a hammer drill, a percussion hammer, a saw, a plane, a screw driver, a milling machine, a grinder, an angle grinder, a garden tool, a building site measuring device and/or a multifunction tool.

The hand tool operating unit in accordance with the disclosure is not to be limited to the above described application and embodiment. In particular, in order to fulfill an operating mode described herein, the hand tool operating unit in accordance with the disclosure can comprise a number of individual elements, components and units that is a different number to the number mentioned herein.

### BRIEF DESCRIPTION OF THE DRAWINGS

Further advantages are evident from the following description of the drawings. The drawings illustrate two exemplary embodiments of the disclosure. The drawings, the description and the claims comprise numerous features in combination.

The person skilled in the art will also consider the features individually in an expedient manner and will combine said features to form expedient further combinations.

In the drawings:

FIG. 1 illustrates a lateral view of a hand tool having a hand tool operating unit in accordance with the disclosure,

FIG. 2 illustrates a perspective view of the hand tool operating unit shown in FIG. 1,

FIG. 3 illustrates a perspective view of a part of the hand tool operating unit shown in FIG. 1 having an open operating unit housing element and an electronic operating unit,

FIG. 4 illustrates a circuit diagram of the electronic operating unit of the hand tool operating unit shown in FIG. 1 having a microcontroller, and

FIG. 5 illustrates an alternative circuit diagram of an electronic operating unit that is embodied using analogue technology.

### DETAILED DESCRIPTION

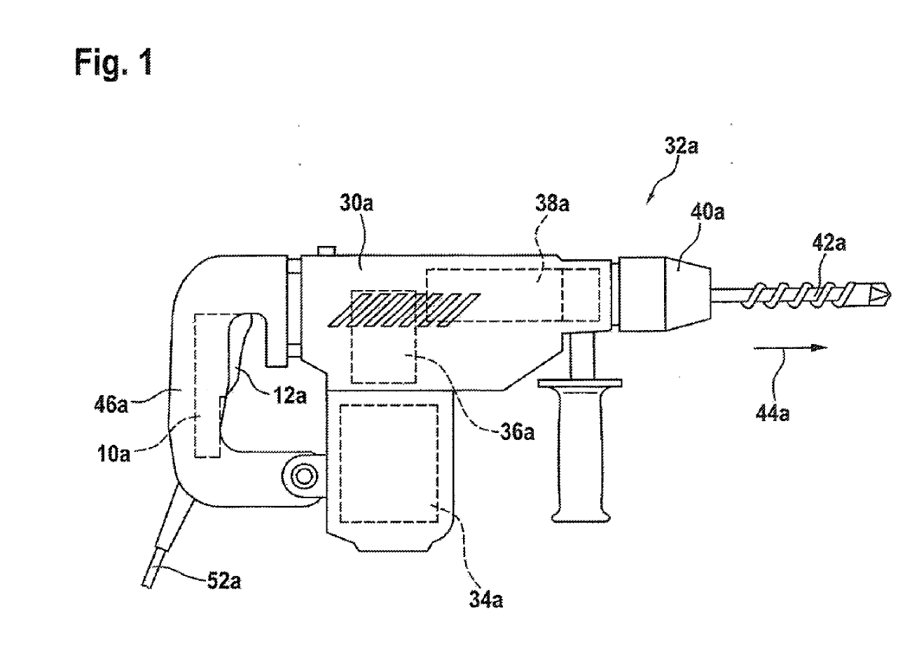

FIG. 1 illustrates a hand tool 32a that is embodied as a hand-held drilling machine. The hand tool 32a comprises the hand tool operating unit in accordance with the disclosure 10a, a hand tool housing 30a, a motor 34a, a gear mechanism 36a, a hammer-action unit 38a and a tool chuck 40a. The motor 34a drives the hammer-action unit 38a and the tool chuck 40a by way of the gear mechanism 36a. When used in a hammer drill operating mode, the hammer-action unit 38a and the tool chuck 40a move a selected tool 42a in a percussive manner and in such a manner as to rotate about an axis of rotation. A main working direction 44a of the hand tool 32a is parallel to the axis of rotation. The hand tool housing 30a forms a D-shaped grip 46a. The hand tool operating unit 10a is integrated essentially in the grip 46a.

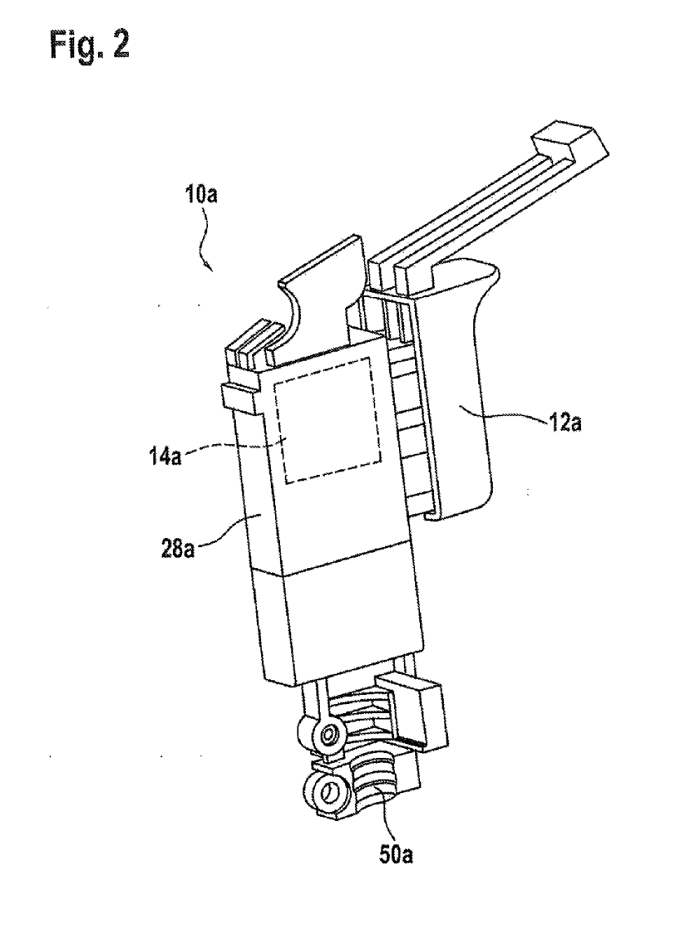

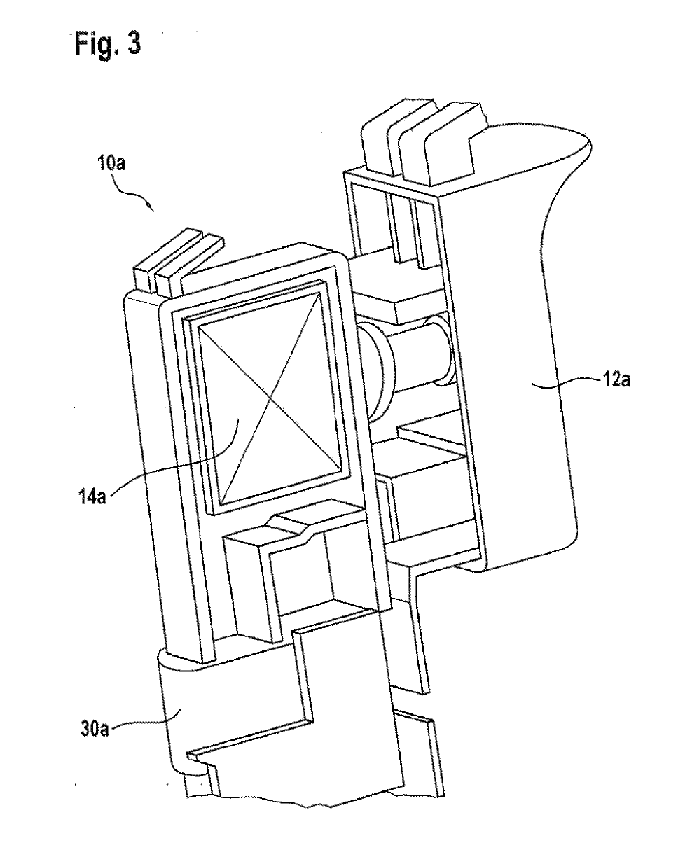

FIGS. 2 and 3 illustrate the hand tool operating unit 10a. The hand tool operating unit 10a comprises an operating means 12a, an electronic operating unit 14a, a motor connector 26a, an operating unit housing element 28a, an energy input 48a and a cable strain relief element 50a. The cable strain relief element 50a is provided for the purpose of fastening a power cable 52a that supplies electrical energy to the hand tool 32a. The energy input 48a is provided for the purpose of connecting insulated conductors of the power cable 52a to the electronic operating unit 14a. Alternatively, a hand tool operating unit in accordance with the disclosure could be provided for the purpose of supplying a motor with power from a hand tool rechargeable battery.

The operating unit housing element 28a connects the operating means 12a, the electronic operating unit 14a, the motor connector 26a, the energy input 48a and the cable strain relief element 50a to form an assembly. During the assembly process, the hand tool operating unit 10a is placed in a first housing shell of the hand tool housing 30a, the energy input 48a is connected to the power cable 52a, the motor connector 26a is connected to the motor 34a by way of a cable (not illustrated in more detail), and the hand tool operating unit 10a is fastened by means of a second housing shell of the hand tool housing 30a. The operating means 12a is mounted so as to be able to move relative to the operating unit housing element 28a. The operating means 12a is mounted so as to be able to move in a translatory manner. The operating means 12a protrudes out of the hand tool housing 30a through a cut-out in the hand tool housing 30a.

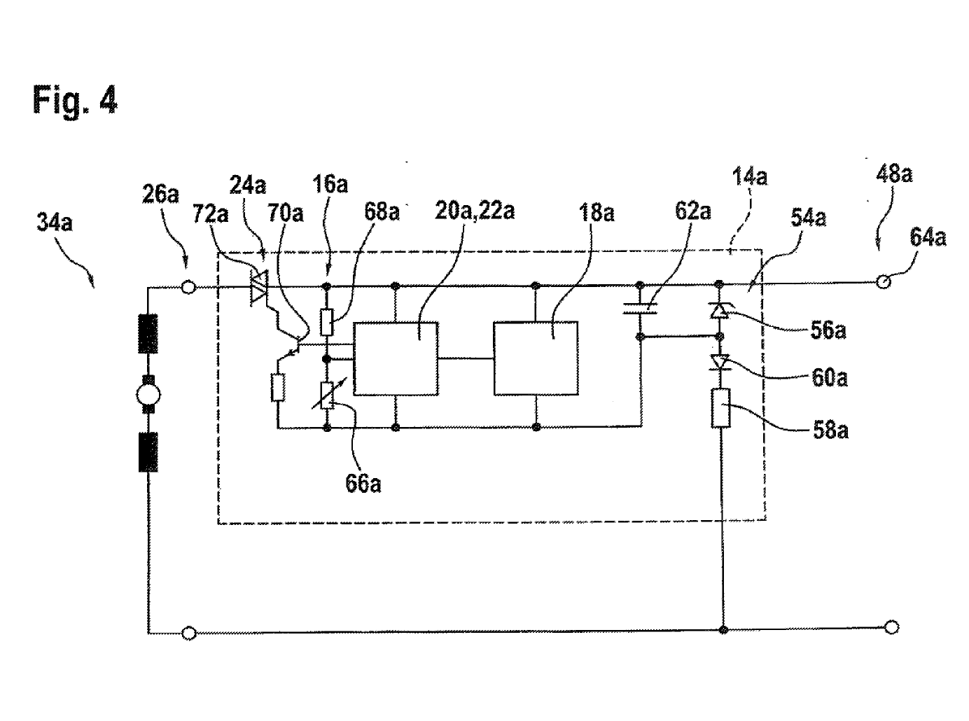

As is illustrated in FIG. 4, the electronic operating unit 14a comprises a position sensor 16a, a further sensor 18a, an evaluating device 20a, a power control means 24a and a voltage supply unit 54a.

The voltage supply unit 54a comprises a Zener diode 56a, a load resistance 58a, a blocking diode 60a and a coupling capacitor 62a. The load resistance 58a produces a current by way of the Zener diode 56a in the case of a positive half-wave of an alternating voltage that is prevailing at the energy input 48a. The coupling capacitor 62a is connected in parallel to the Zener diode 56a, as a consequence of which the coupling capacitor 62a is charged up to the Zener voltage of the Zener diode 56a. The blocking diode 60a prevents the coupling capacitor 62a from discharging in the case of a negative half-wave of the alternating voltage. Consequently, the voltage supply unit 54a provides a supply voltage that corresponds to the Zener voltage of the Zener diode 56a. The supply voltage is in the form of a direct voltage relative to a terminal 64a of the energy input 48a, the coupling capacitor 62a being connected to the energy input 48a.

The further sensor 18a is provided for the purpose of ascertaining a magnitude of acceleration of a movement of an uncontrolled blocking incident. The further sensor 18a is embodied as an acceleration sensor. The further sensor 18a outputs a signal that is dependent upon the acceleration of the further sensor 18a. The signal is embodied as a digital coded signal. The signal is embodied as an I²C signal, as an interrupt signal and/or in particular as an SPI signal. The further sensor 18a transmits an interrupt signal to the evaluating device 20a at least during an accelerating movement that is associated with an uncontrolled blocking incident.

The position sensor 16a is provided for the purpose of outputting a signal that is dependent on a position of the operating means 12a. The position sensor 16a comprises a potentiometer. A part of the potentiometer can be moved by means of the operating means 12a. Consequently, the position sensor 16a comprises a resistance 66a of the potentiometer, said resistance can vary by means of positioning the operating means 12a. The position sensor 16a comprises a further resistance 68a. The variable resistance 66a and the further resistance 68a form a potential divider by way of the voltage supply unit. The signal from the position sensor 16a is in the form of a voltage that is prevailing in the middle of the potential divider. The further resistance 68a is either likewise variable by means of the operating means 12a or said resistance has an essentially constant value.

A microcontroller 22a of the evaluating device 20a captures the signal from the position sensor 16a. The evaluating device 20a is provided for the purpose of evaluating the signal from the further sensor 18a and the signal from the position sensor 16a. During one working procedure, the evaluating device 20a controls the power control means 24a in dependence upon a phase of a supply voltage. The evaluating device 20a is provided for the purpose of interrupting a power supply to the motor 34a at least for a defined period of time in the case of an uncontrolled blocking incident. The evaluating device 20a is consequently provided for the purpose of generating a motor control signal in dependence upon the signal from the position sensor 16a and the signal from the further sensor 18a.

The power control means 24a is provided for the purpose of controlling a driving power that is output by way of the motor connector 26a. The power control means 24a comprises a transistor 70a and a triac 72a. The transistor 70a is embodied as an npn transistor, however, it could also be embodied as a different transistor that appears expedient to the person skilled in the art. If the evaluating device 20a switches the transistor 70a on by means of the motor control signal, a voltage prevails at the triac 72a, as a consequence of which the triac 72a is switched on until the next zero point of the supply voltage. Different switching arrangements that appear expedient to the person skilled in the art are also possible as power control means 24a. The power control means 24a is connected to a terminal of the motor connector 26a. The evaluating device 20a is provided for the purpose of interrupting the output of the driving power by way of the motor connector 26a in dependence upon the signal from the further sensor 18a and in fact in the case of the uncontrolled blocking incident.

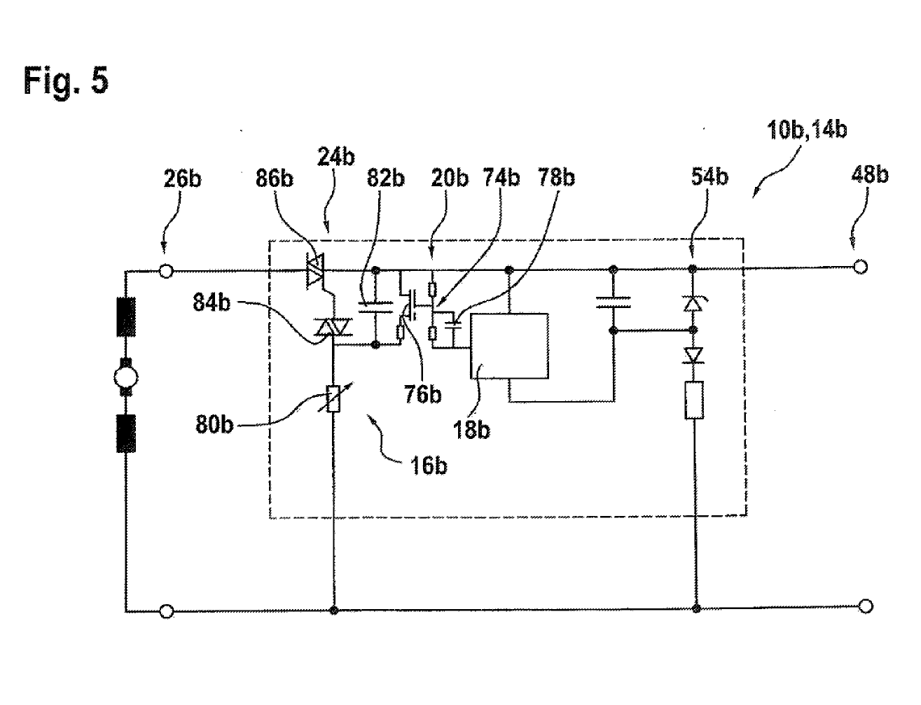

FIG. 5 illustrates a further exemplary embodiment of the disclosure. The descriptions hereinunder and the drawing are limited essentially to the differences between the exemplary embodiments, wherein with regard to like designated components, in particular with regard to components that have like reference numerals, reference can also be made fundamentally to the drawing and/or the description relating to the further exemplary embodiments, in particular to the FIGS. 1 to 4. In order to differentiate between the exemplary embodiments, the letter a is placed after the reference numerals of the exemplary embodiment in FIGS. 1 to 4. In the exemplary embodiment in FIG. 5, the letter a is replaced by the letter b.

FIG. 5 illustrates an alternative exemplary embodiment of an electronic operating unit 14b of a hand tool operating unit 10b in accordance with the disclosure. The electronic operating unit 14b comprises a position sensor 16b, a further sensor 18b, an evaluating device 20b, a power control means 24b and a voltage supply unit 54b. The voltage supply unit 54b is embodied as described in the exemplary embodiment in FIGS. 1 to 4.

The further sensor 18b is provided for the purpose of ascertaining a magnitude of acceleration of a movement of an uncontrolled blocking incident. The further sensor 18b is embodied as an analogue acceleration sensor. The further sensor 18b outputs an analogue signal that is dependent upon the acceleration of the further sensor 18b.

The evaluating device 20b comprises a potential divider 74b and a transistor 76b. The potential divider 74b transmits the signal from the further sensor 18b for the purpose of controlling the transistor 76b. The potential divider 74b comprises a filter capacitor 78b for the purpose of reducing interference.

The position sensor 16b comprises a potentiometer 80b and a capacitor 82b. A part of the potentiometer 80b can be moved by means of the operating means 12b. Consequently, the position sensor 16b comprises a resistance of the potentiometer 80b and said resistance can be varied by means of positioning the operating means. The variable resistance of the potentiometer 80b and the capacitor 82b are connected in series between the two potentials of the supply voltage. The voltage that is prevailing by way of the capacitor 82b consequently lags behind the supply voltage. It is possible by means of the variable resistance of the potentiometer 80b to vary a phase angle between the supply voltage and the voltage that is prevailing at the capacitor 82b. The position sensor 16b is consequently provided for the purpose of generating a motor control signal that is in the form of the voltage that is prevailing at the capacitor 82b.

The power control means 24b comprises a diac 84b and a triac 86b. The diac 84b is connected to a control input of the triac 86b. The triac 86b is arranged on a phase between an energy input 48b and a motor connector 26b. Consequently, the triac 86b of the power control means 24b is provided for the purpose of interrupting an output of a driving power by way of the motor connector 26b. The capacitor 82b of the evaluating device 20b is connected in parallel to the diac 84b. If a voltage that is prevailing at the capacitor 82b exceeds a firing voltage of the diac 84b, said voltage being in other words the motor control signal, the diac 84b is fired and as a consequence switches on the triac 86b. The power control means 24b is consequently embodied as a phase-fired control means. Consequently, it is possible by way of the variable resistance of the position sensor 16b to set a point in time at which the triac 86b is switched on.

If the signal from the further sensor 18b switches on the transistor 76b of the evaluating device 20b, said transistor short circuits the capacitor 82b of the position sensor 16b. The evaluating device 20b is consequently provided for the purpose of influencing the motor control signal. By virtue of short circuiting the capacitor 82b, the triac 86b is prevented from switching on. Consequently, the evaluating device 20b interrupts an output of the driving power by way of the motor connector 26b in dependence upon the signal from the further sensor 18b.

What is claimed is:

1. A hand tool operating unit comprising:
at least one operating member;
an electronic operating unit that includes a position sensor configured to ascertain a position of the operating member; and
at least one further sensor configured to ascertain at least one characteristic variable.

2. The hand tool operating until according to claim 1, wherein the electronic operating unit includes the at least one further sensor.

3. The hand tool operating until according to claim 1, wherein the at least one further sensor is configured to ascertain at least one characteristic variable of a movement of an uncontrolled blocking incident.

4. The hand tool operating until according to claim 1, wherein the at least one further sensor includes an acceleration sensor.

5. The hand tool operating until according to claim 1, further comprising an evaluating device configured to as least one of influence and generate a motor control signal based at least in part upon a signal from the at least one further sensor.

6. The hand tool operating until according to claim 5, wherein the evaluating device is configured to interrupt an output of a driving power based at least in part upon a signal from the at least one further sensor.

7. The hand tool operating until according to claim 5, wherein the evaluating device includes a microcontroller.

8. The hand tool operating until according to claim 5, wherein at least the evaluating device is formed with analogue technology.

9. The hand tool operating until according to claim 1, further comprising a power control element configured to control a driving power.

10. The hand tool operating until according to claim 9, further comprising at least one motor connector configured to output the driving power.

11. The hand tool operating until according to claim 1, further comprising an operating unit housing element that connects the operating member and the electronic operating unit to form an assembly.

12. The hand tool operating until according to claim 11, wherein the operating unit housing element is configured to be installed in a hand tool housing that is at least substantially defined by at least one of a pistol-shaped and D-shaped grip.

13. A hand-held drilling machine, comprising:
a hand tool operating unit that includes:
at least one operating member;
an electronic operating unit that has a position sensor configured to ascertain a position of the operating member; and
at least one further sensor configured to ascertain at least one characteristic variable.
